(19) United States
(12) Patent Application Publication
(10) Pub. No.: US 2021/0001913 A1
(43) Pub. Date: Jan. 7, 2021

(54) DELAY UNIT FOR USE IN A STEERING WHEEL SYSTEM, AND A STEERING WHEEL SYSTEM

(71) Applicant: Sumotomo Wiring Systems, Ltd., Yokkaichi (JP)

(72) Inventors: Vibhor Singh, Farmington, MI (US); Robert C. Grooms, Farmington, MI (US)

(21) Appl. No.: 16/458,335

(22) Filed: Jul. 1, 2019

(51) Int. Cl. B62D 1/04; B62D 1/10; H01H 13/14; B62D 1/28

(52) U.S. Cl. CPC B62D 1/046; B62D 1/28; H01H 13/14; B62D 1/10

(57) ABSTRACT

A delay unit for use in a steering wheel system, the steering wheel system having a steering wheel and a horn actuated by a tactile input configured to provide electric power to a semiconductor switch electrically coupled to the horn. The delay unit includes a semiconductor switch and a time charging unit connected in parallel with the semiconductor unit. The time charging unit is configured to hold a predetermined amount of electric power before electrically connecting the electric power to the semiconductor switch. As such, the time charging unit generates a delay in the transmission of electric power to the semiconductor switch so as to prevent the horn from being actuated when the steering wheel is mounted onto the steering column.

### TECHNICAL FIELD

The present specification generally relates to a delay unit for use in a steering wheel system, and a steering wheel system.

### BACKGROUND

Currently, the steering wheel system includes a steering wheel which is mounted to a steering column of a vehicle. The steering wheel is mounted onto the steering column manually. This requires a force sufficient to seat the steering wheel firmly onto the steering column. The force may be sufficient to actuate the horn switch, e.g. create an incidental actuation. In particular, the force is sufficient to close the horn switch so as to electrically connect the horn with a power supply.

In steering wheel systems having a mechanical relay to actuate the horn, a force sufficient to actuate the horn switch during mounting operations is not an issue as the horn switch is not pressed long enough to provide sufficient power to close the mechanical relay. However, in cases where the steering wheel systems use a semiconductor (such as a MOSFET) instead of a mechanical relay to actuate the horn, an incidental actuation may cause the horn to blow as the semiconductor requires a much smaller voltage, relative to the mechanical relay, to actuate the horn.

According, it remains desirable to have a delay unit in a steering wheel system using a semiconductor to actuate the horn configured so as to prevent the horn from being actuated during mounting operations.

### SUMMARY

A delay unit for use in a steering wheel system, the steering wheel system having a steering wheel and a horn actuated by a tactile input configured to provide electric power to a semiconductor switch electrically coupled to the horn. The delay unit includes a semiconductor switch and a time charging unit connected in parallel with the semiconductor unit. The time charging unit is configured to hold a predetermined amount of electric power before electrically connecting the electric power to the semiconductor switch. As such, the time charging unit generates a delay in the transmission of electric power to the semiconductor switch so as to prevent the horn from being actuated when the steering wheel is mounted onto the steering column.

In one aspect, the time charging unit is configured to generate a delay no longer than 15 milliseconds. In another aspect, the time charging unit is a capacitor and a first resistor connected in series with the capacitor. The delay unit may further include a first diode configured to direct a discharge from the capacitor to a ground. A voltage divider may be electrically coupled to the tactile input so as to divide the electrical power supplied to the time charging unit. A voltage regulator may be configured to regulate the electric power so as to output a predetermined voltage to the time charging unit.

In another aspect of the disclosure, a steering wheel system is provided. The steering wheel is coupled to a power source configured to supply electrical power. The steering wheel system includes a steering wheel, a horn and a tactile input configured to provide the electric power to the horn, so as to actuate the horn.

The steering wheel system further includes a semiconductor switch and a time charging unit. The time charging unit is connected in parallel with the semiconductor unit. The time charging unit is configured to hold a predetermined amount of electric power before electrically connecting the electric power to the semiconductor switch. The time charging unit generates a delay in the transmission of electric power to the semiconductor switch. As such, the steering wheel system generates a delay in the transmission of electric power to the semiconductor switch so as to prevent the horn from being actuated when the steering wheel is mounted onto the steering column.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 is a perspective view showing a steering wheel mounted to a steering wheel column;

FIG. 2 is a schematic view depicting a delay unit according to a first embodiment;

FIG. 3 is a schematic view depicting a delay unit according to a second embodiment;

FIG. 4 is a schematic view depicting a delay unit according to a third embodiment.

### DETAILED DESCRIPTION OF PREFERRED EMBODIMENTS

Referring generally to the figures, embodiments of a delay unit for use in a steering wheel system having a semiconductor switch electrically coupled to the horn are disclosed. The delay unit generates a delay in the transmission of electric power to the semiconductor switch so as to prevent the horn from being actuated when the steering wheel is mounted onto the steering column.

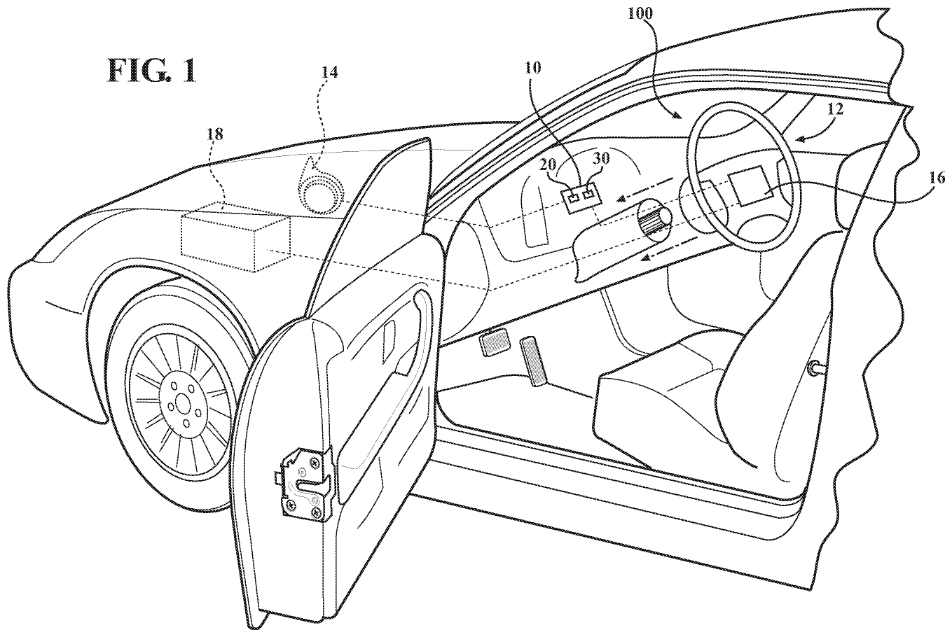

With reference now to FIG. 1, a delay unit 10 for use in a steering wheel system 100 is provided. The steering wheel system 100 includes a steering wheel 12 and a horn 14 actuated by a tactile input 16. For example, tactile input 16 may be a horn switch 16a which may be pressed so as to actuate the horn 14. The horn 14 may be disposed separate from the steering wheel 12, such as on an instrument panel of a vehicle. The horn switch 16a completes an electrical connection from a power source 18 to a semiconductor switch 20. The semiconductor switch 20 is configured to electrically couple the horn 14 to the power source 18. The semiconductor switch 20 is configured to output an electric signal upon receipt of a predetermined voltage.

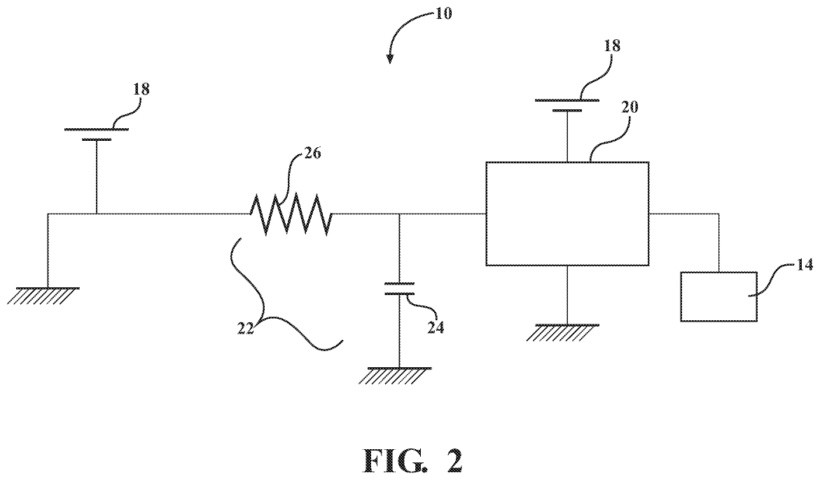

With reference now to FIG. 2, an embodiment of the delay unit 10 is provided. The delay unit 10 includes a time charging unit 22 which is electrically coupled to the semiconductor switch 20. In particular, the time charging unit 22 is connected in parallel with the semiconductor switch 20. The time charging unit 22 is configured to hold a predetermined amount of electric power supplied by the power source 18 before actuating the semiconductor switch 20, so as to generate a delay in the transmission of electric power to the semiconductor switch 20.

When electrical power is transmitted to the semiconductor switch 20, the semiconductor switch 20 is actuated, wherein an electrical connection is made between the power source 18 and the horn 14. For example, the time charging unit 22 is configured to receive a predetermined voltage so as to obtain a predetermined voltage from the power source 18. Upon reaching the predetermined voltage, the time charging unit 22 creates an open circuit so as to electrically connect the semiconductor switch 20 with the power source 18 to the semiconductor switch 20. The semiconductor switch 20 then actuates the horn 14.

For example, the time charging unit 22 may be configured to generate a delay no longer than 15 milliseconds. This may be achieved based upon the specifications of the power source 18 and the specifications of the semiconductor switch 20. For example, the time charging unit 22 may be a capacitor 24 and a first resistor 26 connected in series with the capacitor 24.

The capacitor 24 may be configured to hold the predetermined amount of electric power, e.g. a predetermined amount of voltage. The first resistor 26 is placed in series with the capacitor 24 so as to control the rate in which the capacitor 24 charges or discharges. As is known, when the capacitor 24 reaches a predetermined voltage, the capacitor 24 acts as an open switch and power from the power source 18 is directed to the semiconductor switch 20 which outputs an electric signal to the horn 14.

The first resistor 26 and the capacitor 24 creates a delay based on known physical functions. For example, the equation VIH=(VPower−Ileak*R1)*(1−e\hat{ }(−t/R1*C1)) may be used to determine the delay, wherein “VIH” is the high input voltage threshold for the semiconductor switch 20 to turn on, “Ileak” is the current going into the input of the semiconductor switch 20, “Vpower” is the voltage of the power source 18, “R1” is the resistance of the first resistor 26, “C1” is the farads of the capacitor 24 and “t” is time. Thus, by identifying the voltage threshold of the semiconductor switch 20 and the voltage of the power source 18, the values of the first resistor 26 and the capacitor 24 may be modified to generate a desired delay.

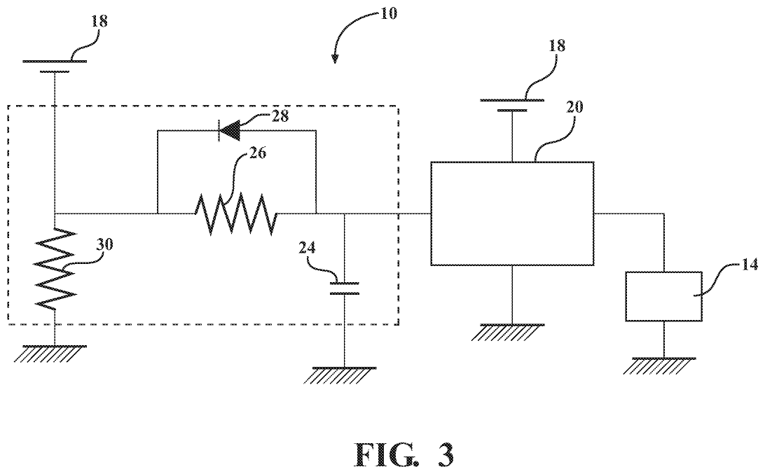

With reference now to FIG. 3 another aspect of the delay unit 10 is provided. In this aspect, the delay unit 10 further includes a first diode 28 and a second resistor 30 configured to direct a discharge from the capacitor 24 to a ground. The first diode 28 is placed in parallel with the first resistor 26. The second resistor 30 is in parallel with the first diode 28. The first diode 28 is configured to direct an electrical discharge from the capacitor 24 to ground. As such, upon a discharge of the capacitor 24, an electric current flows through the first diode 28 to ground. The first diode 28 is configured to have a forward breakover voltage which is smaller than the voltage threshold of the semiconductor switch 20. The current is directed to the second resistor 30 which is grounded.

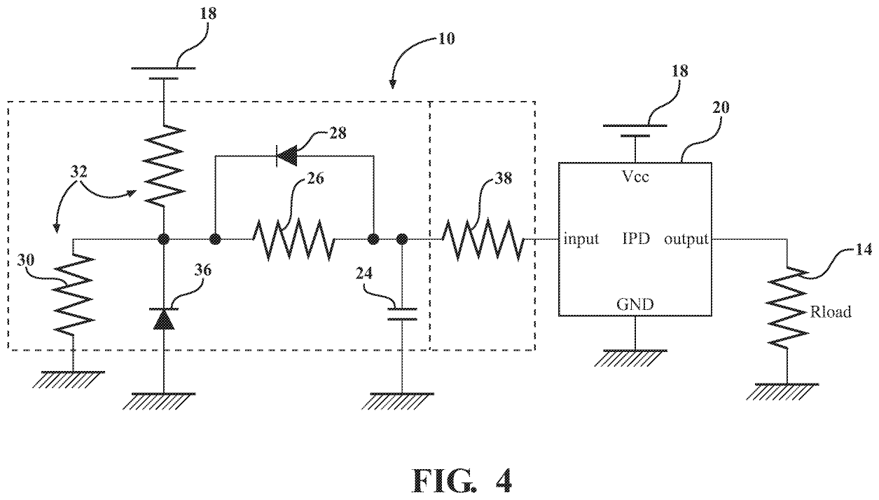

With reference now to FIG. 4, another aspect of the delay unit 10 is provided wherein the delay unit 10 further includes a voltage divider 32 electrically coupled to the tactile input 16 so as to divide the electrical power supplied to the time charging unit 22. The voltage divider 32 includes a third resistor 34. The third resistor 34 and the second resistor 30 are in parallel with each other. The third resistor 34 has a resistance value greater than the second resistor 30 so as to facilitate a discharge from the capacitor 24 to ground.

The delay unit 10 may further include a further a voltage regulator 36 configured to regulate the electric power so as to output a predetermined voltage to the time charging unit 22. In one aspect, the voltage regulator 36 is a Zener diode configured to regulate a voltage from the power source 18 to the time charging unit 22. A voltage regulator 36 may be desirable in applications where the voltage from the power source 18 varies. Further the voltage regulator 36 cooperates with the second resistor 30 so as to help direct a discharge from the capacitor 24 to ground. In particular, the second resistor 30 has a resistance value smaller than the third resistor 34, thus current is directed to the second resistor 30 and into ground.

In applications using a voltage regulator 36, the first resistor 26 and the capacitor 24 creates a delay based on the equation VIH=(VReg−Ileak*R1)*(1−e\hat{ }(−t/R1*C1)). Wherein “VIH” is the high input voltage threshold for the semiconductor switch 20 to turn on, “Ileak” is the current going into the input of the semiconductor switch 20, “Vreg” is the voltage outputted by the voltage regulator 36, “R1” is the resistance of the first resistor 26, “C1” is the farads of the capacitor 24 and “t” is time. Thus, by identifying the voltage threshold of the semiconductor switch 20 and the output voltage of the voltage regulator 36, the values of the first resistor 26 and the capacitor 24 may be modified to generate a desired delay.

A steering wheel system 100 is also disclosed herein. The steering wheel system 100 is coupled to a power source 18 configured to supply electrical power. The steering wheel system 100 includes a steering wheel 12. An illustrative embodiment of a steering wheel 12 is shown in FIG. 1. The steering wheel system 100 further includes a horn 14 and a tactile input 16 configured to provide the electric power to the horn 14. For example, the tactile input 16 may be a horn switch 16a which may be pressed so as to actuate the horn 14. The horn switch 16a completes an electrical connection from a power source 18 to a semiconductor switch 20. The semiconductor switch 20 is configured to electrically connect the power source 18 to the horn 14.

With reference now to FIG. 2, the steering wheel system 100 includes a time charging unit 22 which is electrically coupled to the semiconductor switch 20. It should be appreciated that the time charging unit 22 and the semiconductor switch 20 may be disposed on a printed circuit board. The time charging unit 22 is connected in parallel with the semiconductor switch 20. The time charging unit 22 is configured to hold a predetermined amount of electric power before electrically connecting the electric power to the semiconductor switch 20 so as to generate a delay in the transmission of electric power to the semiconductor switch 20. For example, the time charging unit 22 is configured to receive a predetermined voltage so as to obtain a predetermined voltage from the power source 18. Upon reaching the predetermined voltage, the time charging unit 22 creates an open circuit so as to electrically connect the semiconductor switch 20 with the power source 18. The semiconductor switch 20 is then actuated so as to complete an electrical connection between the power source 18 and the horn 14 so as to actuate the horn 14.

For example, the time charging unit 22 may be configured to generate a delay no longer than 15 milliseconds; however, the delay may be longer or shorter based upon a desired outcome. This may be achieved based upon the specifications of the power source 18 and the specifications of the semiconductor switch 20. For example, the time charging unit 22 may be a capacitor 24 and a first resistor 26 connected in series with the capacitor 24.

The capacitor 24 may be configured to hold the predetermined amount of electric power, e.g. a predetermined amount of voltage. The first resistor 26 is placed in series with the capacitor 24 so as to control the rate in which the capacitor 24 charges or discharges. As is known, when the capacitor 24 reaches a predetermined voltage, the capacitor 24 acts as an open switch and power from the power source 18 is directed to the semiconductor switch 20 which outputs an electric signal to the horn 14.

The first resistor 26 and the capacitor 24 creates a delay based on the equation:

VIH=(VPower−Ileak*R1)*(1−e\hat{ }(−t/R1*C1)).

Wherein “VIH” is the high input voltage threshold for the semiconductor switch 20 to turn on, “Ileak” is the current going into the input of the semiconductor switch 20, “Vpower” is the voltage of the power source 18, “R1” is the resistance of the first resistor 26, “C1” is the farads of the capacitor 24 and “t” is time. Thus, by identifying the voltage threshold of the semiconductor switch 20 and the voltage of the power source 18, the values of the first resistor 26 and the capacitor 24 may be modified to generate a desired delay.

With reference now to FIG. 3 another aspect of the steering wheel system 100 is provided wherein the steering wheel system 100 further includes a first diode 28 configured to direct a discharge from the capacitor 24 to a ground. The first diode 28 is placed in parallel with the first resistor 26. The first diode 28 is configured to direct an electrical discharge from the capacitor 24 to ground. As such, upon a discharge of the capacitor 24, an electric current flows through the first diode 28 to ground. The first diode 28 is configured to have a forward breakover voltage which is smaller than the voltage threshold of the semiconductor.

With reference now to FIG. 4, another aspect of the steering wheel system 100 is provided wherein the steering wheel system 100 further includes a voltage divider 32 electrically coupled to the tactile input 16 so as to divide the electrical power supplied to the time charging unit 22. The voltage divider 32 includes a second resistor 30 and a third resistor 34. The third resistor 34 has a resistance value greater than the second resistor 30 so as to facilitate a discharge from the capacitor 24 to ground.

The steering wheel system 100 may further include a further a voltage regulator 36 configured to regulate the electric power so as to output a predetermined voltage to the time charging unit 22. In one aspect, the voltage regulator 36 is a Zener diode configured to regulate a voltage from the power source 18 to the time charging unit 22. A voltage regulator 36 may be desirable in applications where the voltage from the power source 18 varies. Further the voltage regulator 36 cooperates with the second resistor 30 so as to help direct a discharge from the capacitor 24 to ground.

In applications using a voltage regulator 36, the first resistor 26 and the capacitor 24 creates a delay based on the equation:

VIH=(VReg−Ileak*R1)*(1−e\hat{ }(−t/R1*C1)).

Wherein “VIH” is the high input voltage threshold for the semiconductor switch 20 to turn on, “Ileak” is the current going into the input of the semiconductor switch 20, “Vreg” is the voltage outputted by the voltage regulator 36, “R1” is the resistance of the first resistor 26, “C1” is the farads of the capacitor 24 and “t” is time. Thus, by identifying the voltage threshold of the semiconductor switch 20 and the output voltage of the voltage regulator 36, the values of the first resistor 26 and the capacitor 24 may be modified to generate a desired delay.

The steering wheel system 100 may further include a fourth resistor 38. The fourth resistor 38 is configured to provide an input resistance to the semiconductor switch 20. In particular, in instances where the semiconductor switch 20 has a relatively low voltage tolerance with respect to the voltage of the power source, the fourth resistor 38 helps prevent the semiconductor switch 20 from being shorted.

In operation, the time charging unit 22 is configured to provide a delay in the actuation of the horn 14. The delay is configured to prevent an inadvertent actuation of the horn 14 as a result of a force applied for purposes other than actuating the horn 14. For example, the force may be a result of mounting the steering wheel 12 onto the steering column. Such a force produces a jolt which may be sufficient to cause the horn switch 16a to close, thereby transmitting electrical power to the semiconductor switch 20. However, the temporary closing of the switch directs power to the capacitor 24 which prevents the semiconductor from receiving the electric power from the closed switch.

If an intended force is applied to the horn switch 16a, e.g. longer than a jolt resulting from mounting the steering wheel 12 onto the steering column, the horn switch 16a is closed and electric power is collected by the capacitor 24 unit the capacitor 24 reaches a predetermined voltage wherein the capacitor 24 then serves as an open circuit and electric power is inputted to the semiconductor switch 20 and the horn 14 is actuated.

For example, a desirable delay in automotive application may be 15 milliseconds. This delay may be based upon the power source 18 having an output of 12 volts. The power source is a battery which may be configured to supply power to other vehicle loads, or may generate voltage when battery charging operations occur. As such, it may be desirable to have a delay unit 10 with voltage regulating functions.

A 15 millisecond delay may be achieved using the equation VIH=(VPower−Ileak*R1)*(1−e\hat{ }(−t/R1*C1)) made in reference to FIG. 4, wherein “VIH” is the high input voltage threshold for the semiconductor switch 20 to turn on, “Ileak” is the current going into the input of the semiconductor switch 20, “Vpower” is the voltage of the power source 18 and has a value of 12 volts, “R1” is the resistance of the first resistor 26 and has a value of 15 kΩ, “C1” is the farads of the capacitor 24 and has a value of 1.5 μF. The value of the third resistor 34 is 2 kΩ. The value of the second resistor 30 is 5.1 kΩ. The value of the voltage regulator is 5.1V, that is the voltage regulator is design to provide a constant voltage of 5.1 volts. Using these specification, VIH is 1.86 volts and Ileak is 3.3 μA. Thus, by identifying the voltage threshold of the semiconductor switch 20 and the voltage of the power source 18, the values of the first resistor 26 and the capacitor 24 may be modified to generate a desired delay.

Thus, once the delay unit 10 generates the delay, the semiconductor switch 20 is actuated so as to be closed, wherein an electrical connection between the power source 18 and the horn 14 is made, actuating the horn after 15 milliseconds.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A delay unit for use in a steering wheel system, the steering wheel system having a steering wheel and a horn actuated by a tactile input configured to provide an electric power to the horn, the delay unit comprising:
a semiconductor switch and a time charging unit connected in parallel with the semiconductor switch, the time charging unit configured to hold a predetermined amount of electric power before electrically connecting the electric power to the semiconductor switch so as to generate a delay in a transmission of the electric power to the semiconductor switch.

2. The delay unit as set forth in claim 1, wherein the delay is no longer than 15 milliseconds.

3. The delay unit as set forth in claim 1, wherein the time charging unit is a capacitor and a first resistor connected in series with the capacitor.

4. The delay unit as set forth in claim 3, wherein the time charging unit includes a first diode and a second resistor configured to direct a discharge from the capacitor to a ground.

5. The delay unit as set forth in claim 3, wherein the time charging unit includes a voltage divider electrically coupled to the tactile input so as to divide the electrical power supplied to the time charging unit.

6. The delay unit as set forth in claim 4, further including a voltage regulator configured to regulate the electric power so as to output a predetermined voltage to the time charging unit.

7. The delay unit as set forth in claim 6, further wherein the voltage regulator is a Zener diode.

8. A steering wheel system coupled to a power source configured to supply an electric power, the steering wheel system comprising:
a steering wheel;
a horn;
a tactile input configured to provide the electric power to the horn, so as to actuate the horn;
a semiconductor switch and a time charging unit connected in parallel with the semiconductor switch, the time charging unit configured to hold a predetermined amount of electric power before electrically connecting the electric power to the semiconductor switch so as to generate a delay in a transmission of the electric power to the semiconductor switch.

9. The steering wheel system as set forth in claim 8, wherein the delay is no longer than 15 milliseconds.

10. The steering wheel system as set forth in claim 8, wherein the time charging unit is a capacitor and a first resistor connected in series with the capacitor.

11. The steering wheel system as set forth in claim 10, wherein the time charging unit includes a first diode and a second resistor configured to direct a discharge from the capacitor to a ground.

12. The steering wheel system as set forth in claim 10, wherein the time charging unit includes a voltage divider electrically coupled to the tactile input so as to divide the electrical power supplied to the time charging unit.

13. The steering wheel system as set forth in claim 10, further including a voltage regulator configured to regulate the electric power so as to output a predetermined voltage to the time charging unit.

14. The steering wheel system as set forth in claim 13, wherein the voltage regulator is a Zener diode configured to direct a discharge from the capacitor to a ground.

15. The steering wheel system as set forth in claim 13, further including a fourth resistor configured to provide a predetermined voltage to the semiconductor switch.
